(19) United States
(12) Patent Application Publication
(10) Pub. No.: US 2010/0177612 A1
(43) Pub. Date: Jul. 15, 2010

(54) INFORMATION RECORDING APPARATUS AND COPY MANAGEMENT PROGRAM

(75) Inventors: Yuji Shimizu, Kodaira-shi (JP); Takeshi Koda, Kodaira-shi (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, TOKYO (JP)

(21) Appl. No.: 12/594,090

(22) PCT Filed: Mar. 30, 2007
(86) PCT No.: PCT/JP2007/057274

§ 371 Date: Mar. 16, 2010

(51) Int. Cl. G11B 27/36

(52) U.S. Cl. 369/53.21; G9B/27.052

(57) ABSTRACT

An information recording apparatus mutually communicates with a number-of-copying-times management server via a communication network, the server performing management by correlating medium identification information that enables unique identification of an information recording medium, with information related to number of allowable copying times of digital contents recorded on the information recording medium. The apparatus acquires the medium identification information of the inserted information recording medium, and acquires information related to the number of allowable copying times correlated with the acquired medium identification information, from the number-of-copying-times management server, for recordation in a storage unit. When a user's request is received to display the information related to the number of allowable copying times, the information related to the number of allowable copying times recorded in the storage unit is correlated with the medium identification information and outputted to and displayed on a display unit.

### TECHNICAL FIELD

The present invention relates to a technique of managing a copying process for digital contents, and in particular, to a technique that can be favorably applied to an information recording apparatus compatible with Managed Copy.

### BACKGROUND ART

A standard called Managed Copy is specified in AACS (Advanced Access Content System) which is based on a digital contents protection technique used in the next generation of optical discs, such as Blu-ray and HD DVD. Managed Copy refers to a function of allowing copying of digital contents by performing authentication via a network. For example, in the case where copying is performed using an information recording apparatus compatible with Managed Copy (e.g. Blu-ray disc recorder), a purchased optical disc is inserted into the apparatus first. Then, the information recording apparatus is adapted to make an inquiry to a Managed Copy server that manages the number of copying times, through the use of the disc ID recorded on the optical disc, or the disc ID that has been produced using information recorded on the optical disc and information given by other means. In response, the information recording apparatus is adapted to acquire information on the number of copying times, based on which the information recording apparatus is adapted to determine whether or not a copying process can be performed, and finally realize the copying process.

Prior art documents dealing with the number of copying times management related to the present application include the following documents.

Patent Document 1: Japanese Patent Application Laid-Open Publication No. 2004-246996

Patent Document 21: Japanese Patent Application Laid-Open Publication No. 2001-250324

### DISCLOSURE OF THE INVENTION

### Problems to be Solved by the Invention

As described above, in the Managed Copy standard, the information on the number of copying times of an optical disc in question is ensured to be acquired through an inquiry to the Managed Copy server when the copying process is executed. Therefore, there is a problem that, unless the optical disc is inserted into the information recording apparatus, the information recording apparatus cannot acquire the information concerning the number of copying times. In other words, there is a problem that, unless the optical disc is inserted into the information recording apparatus, the information concerning the number of copying times cannot be presented to the user. Under such conditions, it is very inconvenient for the user to keep track of the information concerning the number of copying times of the optical disc, and thus good practical use cannot be realized.

The present invention has been made in light of the circumstances described above, and has its issue, as an example, of providing an information recording apparatus and a copy management program, with which the user can be conveniently presented with information concerning the number of copying times of the digital contents recorded on an information recording medium.

### Means for Solving the Problem

In order to achieve the issue mentioned above, an information recording apparatus recited in claim 1 is an information recording apparatus which is mutually communicable with a number-of-copying-times management server via a communication network, the server performing management by correlating medium identification information that enables unique identification of an information recording medium with information related to number of allowable copying times of digital contents recorded on the information recording medium, and is characterized in that the apparatus comprises: medium identification information acquiring means that acquires medium identification information of an inserted information recording medium; first number-of-copying-times information acquiring means that acquires information related to number of allowable copying times from the number-of-copying-times management server, the number of allowable copying times being correlated with the medium identification information that has been acquired by the medium identification information acquiring means; number-of-copying-times information recording means that records copy management information in a given storage unit, the copy management information being the information in which the medium identification information acquired by the medium identification information acquiring means is correlated with information related to the number of allowable copying times acquired by the first number-of-copying-times information acquiring means; and number-of-copying-times displaying/controlling means that effects control so that the copy management information recorded in the given storage unit can be displayed on or outputted to a given display unit, when a display request for the information related to the number of allowable copying times is received from a user.

Further, a copy management program recited in claim 8 is a copy management program readable by an information recording apparatus which is mutually communicable with a number-of-copying-times management server via a communication network, the server performing management by correlating medium identification information that enables unique identification of an information recording medium with information related to number of allowable copying times of digital contents recorded on the information recording medium, and is characterized in that the program permits the information recording apparatus to function as: medium identification information acquiring means that acquires medium identification information of an inserted information recording medium; first number-of-copying-times information acquiring means that acquires information related to number of allowable copying times from the number-of-copying-times management server, the number of allowable copying times being correlated with the medium identification information that has been acquired by the medium identification information acquiring means; number-of-copying-times information recording means that records copy management information in a given storage unit, the copy management information being the information in which the medium identification information acquired by the medium identification information acquiring means is correlated with information related to the number of allowable copying times acquired by the first number-of-copying-times information acquiring means; and number-of-copying-times displaying/controlling means that effects control so that the copy management information recorded in the given storage unit can be displayed on or outputted to a given display unit, when a display request for the information related to the number of allowable copying times is received from a user.

### BRIEF DESCRIPTION OF THE DRAWINGS

FIG. 1 is a schematic configuration diagram illustrating a copy management system related to an embodiment of the present invention;

FIG. 2 is a configuration diagram illustrating copy management information managed by a Managed Copy authentication server of the copy management system related to the embodiment of the present invention;

FIG. 3 is a function block diagram illustrating a Managed Copy compatible information recording apparatus of the copy management system related to the embodiment of the present invention;

FIG. 4 is a configuration diagram illustrating copy management information managed by the Managed Copy compatible information recording apparatus of the copy management system related to the embodiment of the present invention;

FIG. 5 is a flow diagram illustrating a copying process performed by the Managed Copy compatible information recording apparatus of the copy management system related to the embodiment of the present invention;

FIG. 6 is a flow diagram illustrating a number-of-copying-times information displaying process performed by the Managed Copy compatible information recording apparatus of the copy management system related to the embodiment of the present invention;

FIG. 7 is a view illustrating an example of an image display resulting from the number-of-copying-times information displaying process illustrated in FIG. 6;

FIG. 8 is a flow diagram illustrating a number-of-copying-times information updating process 1 performed by the Managed Copy compatible information recording apparatus of the copy management system related to the embodiment of the present invention;

FIG. 9 is a schematic configuration diagram illustrating a copy management system related to another embodiment of the present invention; and

FIG. 10 is a flow diagram illustrating a number-of-copying-times information updating process 2 performed by a Managed Copy compatible information recording apparatus of the copy management system related to another embodiment of the present invention.

### DESCRIPTION OF SYMBOLS

1: Managed Copy authentication server
2: Managed Copy compatible information recording apparatus
3: Communication network
4: LAN
10, 20: Copy management system
101: Number-of-copying-times management DB
102: Control unit
103: Communication unit
110, 220: Copy management information
111, 221: Disc ID
112, 222: Number of copying times information
113, 223: Copy restriction item related information
224: Contents attribute information
225: Update time and date
201: HDD
202: BD/DVD drive
203: Card I/F
204: Ethernet (registered trademark) I/F
205: USB IF
206: Digital tuner
207: Video ADC
208: Audio ADC
209: HDMI IF
210: Video DAC
211: Audio DAC
212: AV pre/post processor
213: AV encoder
214: AV decoder
215: Stream processor
216: CPU
217: Nonvolatile memory
218: Primary memory

BEST MODES FOR EMBODYING THE INVENTION

With reference to the drawings, hereinafter will be described some embodiments of the present invention.

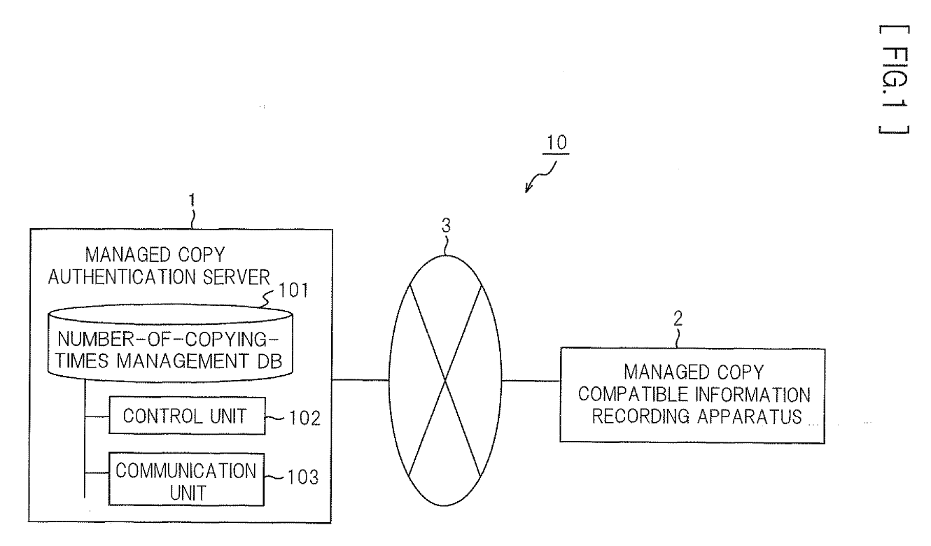

FIG. 1 is a schematic configuration diagram illustrating a copy management system 10 related to an embodiment of the present invention. The copy management system 10 shown in FIG. 1 is a computer system in conformity with the Managed Copy standard. The copy management system 10 is provided with a Managed Copy authentication server 1, a Managed Copy compatible information recording apparatus 2 and a communication network 3, such as Internet, that enables mutual communication between the Managed Copy authentication server 1 and the Managed Copy compatible information recording apparatus 2. In the case where the Managed Copy compatible information recording apparatus 2 carries out a copying process for the digital contents recorded on an information recording medium (optical disc) with such a configuration, the Managed Copy compatible information recording apparatus 2 gains access to the Managed Copy authentication server 1. In response, the Managed Copy authentication server 1 that manages number of copying times information gives permission to the Managed Copy compatible information recording apparatus 2 to perform the copying process, so that the copying process can be performed in the Managed Copy compatible information recording apparatus 2.

The following description will be provided taking a BD (Blur-ray Disc) recorder, one of the next generation DVD recorders, as the Managed Copy compatible information recording apparatus 2. However, this is not intended to impose a limitation on the information recording apparatus, but any information recording apparatus may be used if it is compatible with the Managed Copy standard. For example, an HD DVD (High Definition DVD) recorder, DVD recorder, HDD recorder, AV server, computer, or the like may be used. Also, a next generation DVD player, such as a BD player and HD DVD player, as well as a reproducing apparatus, such as a DVD player, may be used if it is in conformity with the Managed Copy standard and enables a copying process. Further, in the present embodiment, the copy management system 10 is described as a computer system in conformity with the Managed Copy standard, However, this is not intended to impose a limitation on the copy management system. A system configuration may be based on any standard, or the like, if the system configuration is provided with a server apparatus that receives and manages number of copying times information of the digital contents recorded on an information recording medium, permits an information recording apparatus to communicate with the server apparatus via a communication network to obtain authentication, and controls availability of a copying process based on the number of copying times information acquired from the server apparatus.

The Managed Copy authentication server (hereinafter referred to as a “server”) 1 corresponds to a number-of-copying-times management server that manages the number of copying times for each information recording medium (optical disc). Specifically, as shown in FIG. 1, the server 1 is configured by a number-of-copying-times management database (hereinafter referred to as a “number-of-copying-times management DB) 101, a control unit 102 and a communication unit 103.

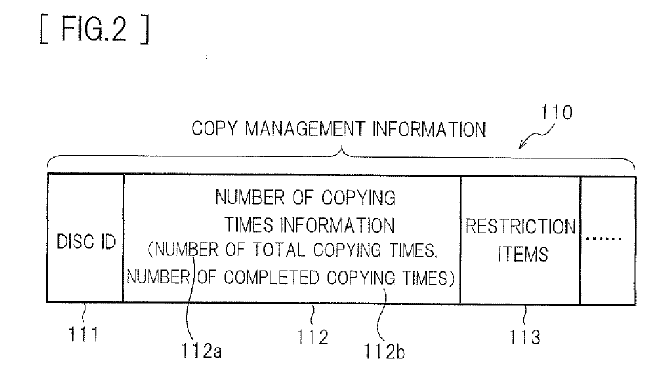

The number-of-copying-times management DB 101 is a database that manages the number of copying times information for each information recording medium (optical disc). Specifically, as shown in FIG. 2, the number-of-copying-times management DB 101 stores and manages copy management information 110 including such items as a disc ID 111, number of copying times information 112 and copy restriction item related information 113. In the present embodiment, the disc ID 111 is configured by combining a pre-recorded media serial number and a contents ID, that is, the disc ID 111 corresponds to information that can univocally identify an optical disc. Any information may be used alternative to the disc ID 111, if only the information can univocally identify an optical disc. With the number of copying times information 112, the number of allowable copying times currently available is managed. Specifically, the number of copying times information 112 is configured by number of total copying times (the maximum number of copying times preset to the optical disc) 112a and number of completed copying times (the number of times of copying already finished) 112b. For example, when the number of total copying times is three and the number of completed copying times is one, two more copying processes remains as being available currently. With the copy restriction item related information 113, restriction items are managed in the case where some restrictions are placed on the copying process, such as the case where a restriction is placed on the type of the information recording medium of copy destination (e.g., copy destination is restricted to VGA size or less).

The control unit 102 is configured by a central processing unit (CPU) at least having functions of calculation and control, and a main storage unit consisting such as of ROM and RAM having a function of storing programs and data. Thus, the control unit 102 is adapted to control the server 1 as a whole.

The communication unit 103 is adapted to perform data transmission/reception with the Managed Copy compatible information recording apparatus 2 via the communication network 3.

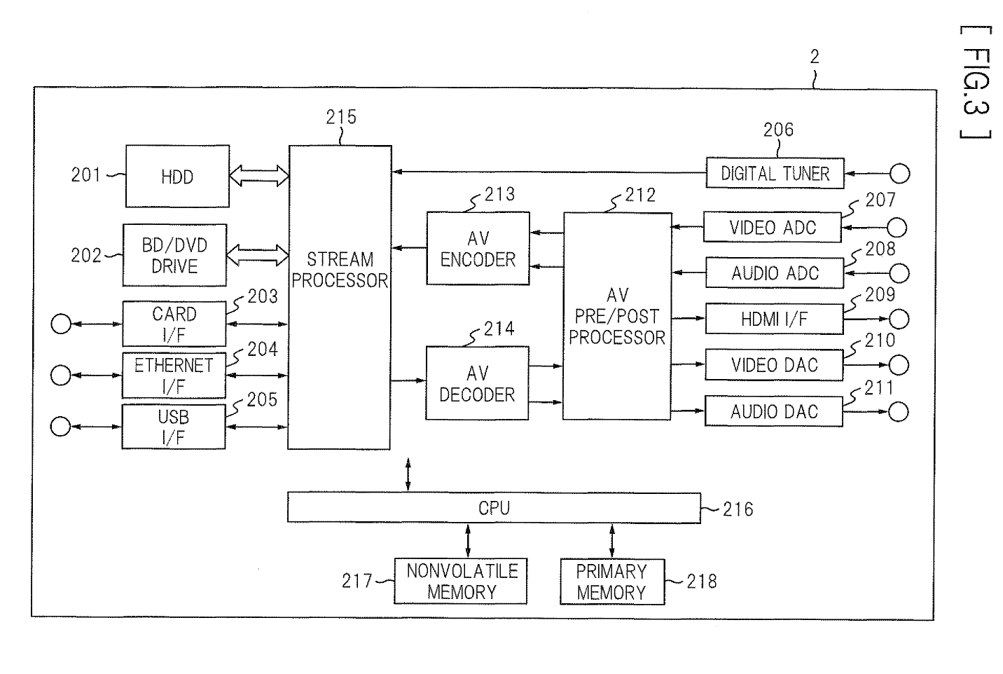

FIG. 3 is a function block diagram illustrating the Managed Copy compatible information recording apparatus (hereinafter referred to as an “information recording apparatus) 2. The information recording apparatus 2 is provided with an HDD 201 and a BD/DVD drive 202 and performs recording/reproduction of data for the hard disc and recording/reproduction of data for a BD/DVD. Also, the information recording apparatus 2 is able to communicate with externally-connected machinery, such as a memory card, a network device and a USB device via an interface, such as a card I/F 203, an Ethernet (registered trademark) I/F 204 and a USB I/F 205. In the present embodiment, the digital contents recorded on an optical disc (BD/DVD) can be subjected to a copying process for recordation on an optical disc, hard disc, and so forth, externally-connected machinery.

A digital tuner 206 receives digital broadcasting. A video ADC (video A/D converter) 207 performs analog-digital conversion of image signals inputted from external machinery. An audio ADC (audio A/D converter) 208 performs analog-digital conversion of audio signals inputted from external machinery. An HDMI (High-Definition Multimedia Interface) IF 209 performs interface conversion of image signals, audio signals and control signals according to HDMI standards. A video DAC (video D/A converter) 210 performs digital-analog conversion of image signals and outputs the converted analog image signals to external machinery. An audio DAC (audio D/A converter) 211 performs digital-analog conversion of audio signals and outputs the converted analog audio signals to external machinery.

An AV pre/post processor 212 performs pre-processing of image information and audio information inputted via the video ADC 207 and the audio ADC 208, and in particular, performs processes such as a time axis correction process and image quality improvement process. Also, the AV pre/post processor 212 performs post-processing of image information and audio information, and in particular performs processes, such as an image quality improvement process, a composition process, a pixel conversion process and a frame conversion process and outputs the resultant signals to the HDMI IF 209, the video DAC 210 and the audio DAC 211.

An AV encoder 213 performs encoding and multiplexing processes for the image signals and the audio signals outputted from the AV pre/post processor 212 and outputs the resultant signals to a stream processor 215. An AV decoder 214 performs decoding and data separation processes for the image signals and the audio signals inputted from the stream processor 215, and outputs the resultant signals to the AV pre/post processor 212. In the present embodiment, in the case of different application formats, such as the case of making a copy between different information recording media, code conversion is performed via the AV decoder 214 and the AV encoder 213.

The stream processor 215 performs data transmission control, and data encryption and decryption processes.

A CPU 216 serves as operating/controlling means for the information recording apparatus 2. A nonvolatile memory 217 serves as storing means for programs and data. A primary memory 218 serves as primary storing means for stream data and display data.

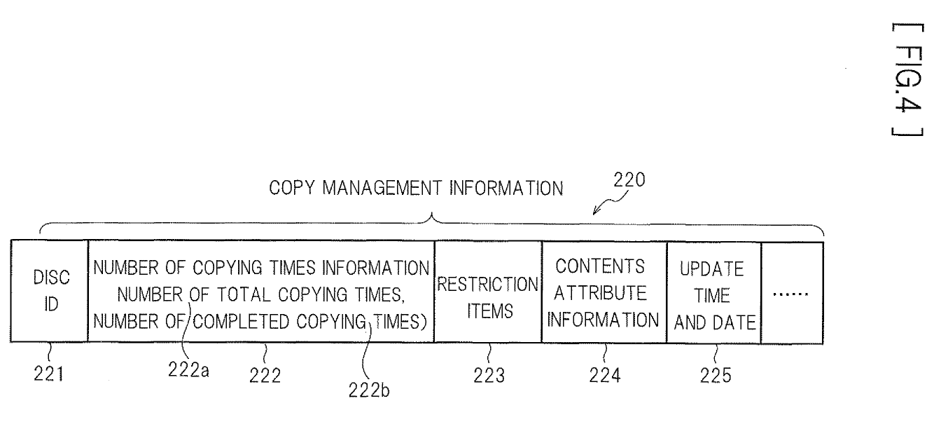

The nonvolatile memory 217 stores copy management information 220 managed for each information recording medium (optical disc). The copy management information 220 is the information prepared on the basis of the copy management information 110 acquired from the server 1, and has substantially the same configuration as that of the copy management information 110. However, in addition to the items of the copy management information 110, the copy management information 220 is provided with such items as contents attribute information (e.g., title, performer information, genre information and jacket image of the contents) and update time and date. In other words, as shown in FIG. 4, the copy management information 220 is specifically configured by such information as a disc ID 221, number of copying times information 222 (specifically, number of total copying times 222a, number of completed copying times 222b), copy restriction item related information 223, contents attribute information 224 and update time and date 225. The contents attribute information 224 may be ensured to be acquired from the optical disc mounted on the information recording apparatus 2, or may be ensured to be acquired from a server that manages contents attribute information via the communication network 3 (or the server 1 if the contents attribute information is held by the server 1).

The nonvolatile memory 217 stores a program that executes various processes to be performed by the information recording apparatus 2, which will be described later. Besides being stored in the nonvolatile memory 217, this program may be recorded on a computer readable recording medium, such as a hard disc, flexible disc, CD-ROM and DVD-ROM, or may be delivered via a communication network.

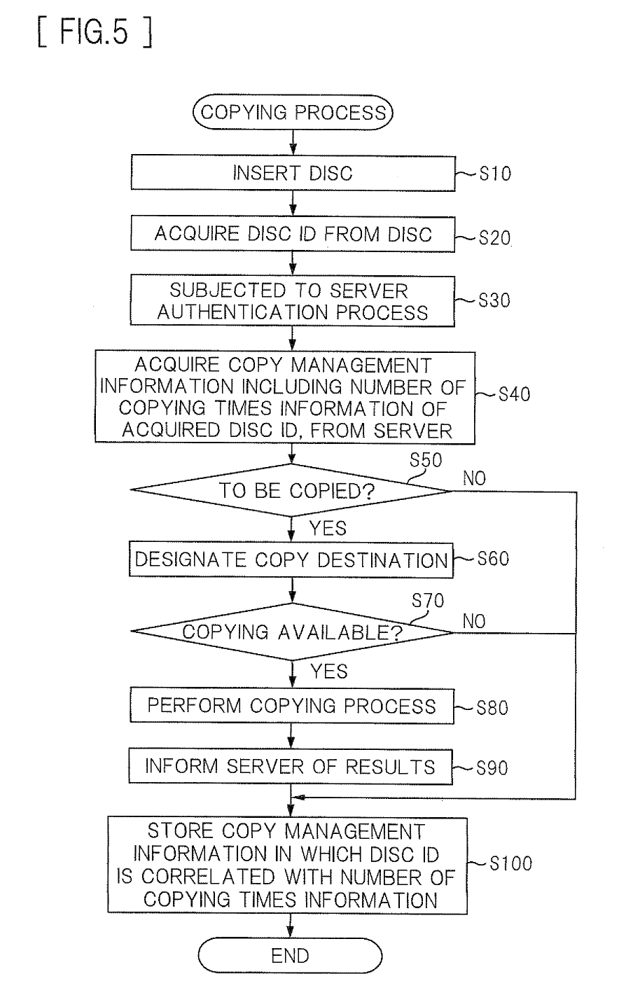

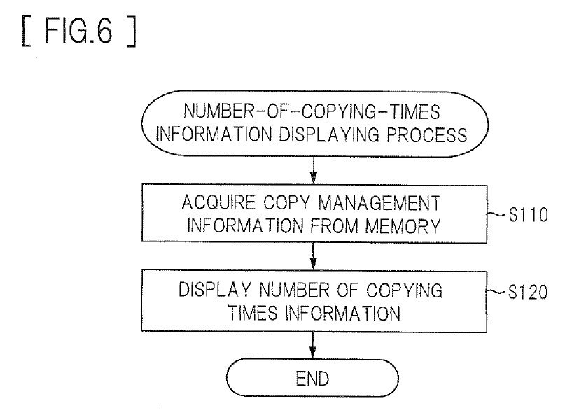

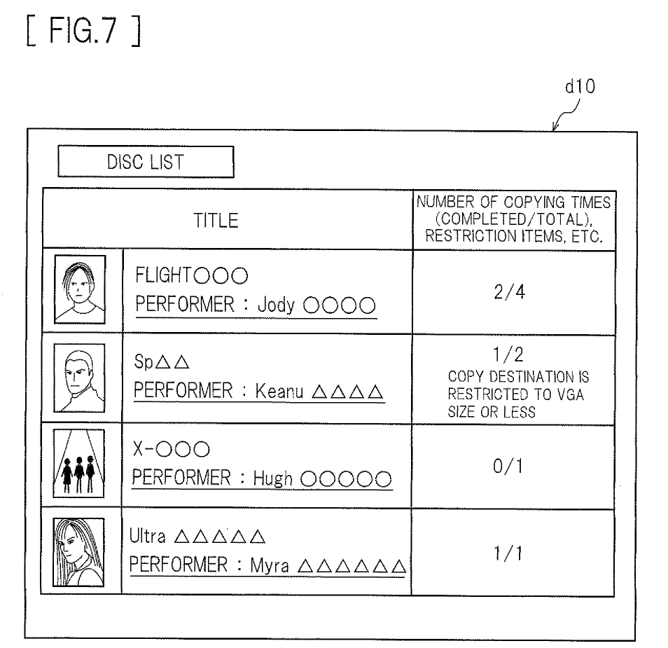

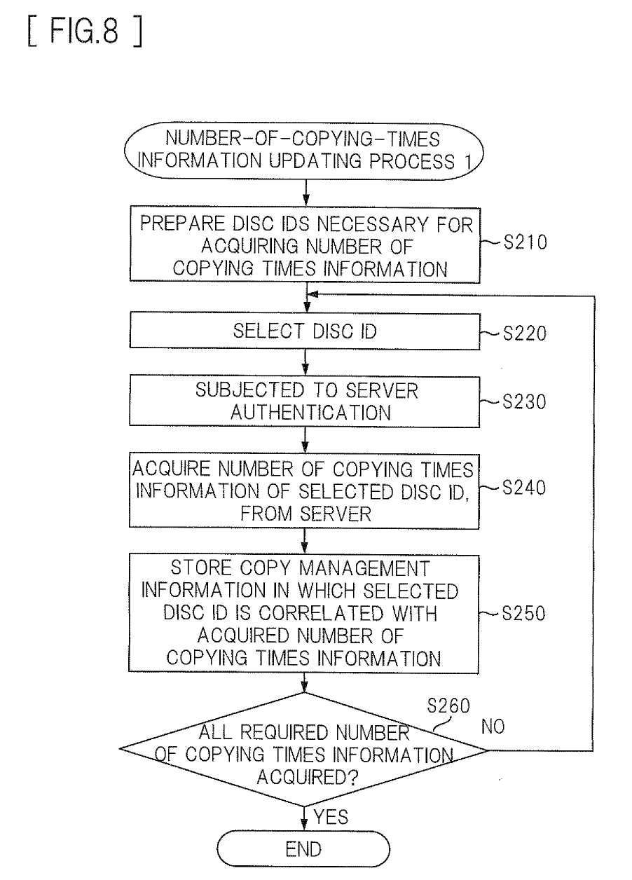

Referring now to FIGS. 5 to 8, hereinafter is described an operation of the information recording apparatus 2 in the copy management system 10. FIG. 5 is a flow diagram illustrating a copying process performed by the information recording apparatus 2. FIG. 6 is a flow diagram illustrating a number-of-copying-times information displaying process performed by the information recording apparatus 2. FIG. 8 is a flow diagram illustrating a number-of-copying-times information updating process 1 performed by the information recording apparatus 2. FIG. 7 illustrates an example of a screen display when the information recording apparatus 2 has displayed the number of copying times information. It should be appreciated that the processes illustrated in FIGS. 5, 6 and 8 are performed under the control of the CPU 216 of the information recording apparatus 2.

First, referring to FIG. 5, the copying process performed by the information recording apparatus 2 is described.

With the insertion of an optical disc located by a user (step S10), the information recording apparatus 2 acquires a disc ID from the optical disc (step S20).

Then, the information recording apparatus 2 gains access to the server 1 via the communication network 3, based on the acquired disc ID to thereby perform a server authentication process (step S30).

The information recording apparatus 2 authenticated by the server 1 acquires the copy management information 110 from the server 1 (step S40). More specifically, based on the disc ID of the inserted optical disc, the information recording apparatus 2 acquires the copy management information 110 including the number of copying times information 112 of the disc ID in question and the copy restriction item related information 113, from the number-of-copying-times management DB 101.

Then, the information recording apparatus 2 determines whether or not a copying process has been selected by the user (step S50). When the copying process has been selected (YES at step S50), the information recording apparatus 2 receives designation of an information recording medium of copy destination from the user (step S60).

Then, the information recording apparatus 2 determines whether copying is available (step S70). If copying is determined to be available, based on the number of copying times information 112 and the copy restriction item related information 113 in the acquired copy management information 110 (YES at step S70), the information recording apparatus 2 performs the copying process (step S80) and informs the server 1 of the results of the copying process (step S90). Upon reception of the information that the copying process has been successfully completed from the information recording apparatus 2, the server 1 increments by “1” the number of completed copying times 112b of the disc ID 111 in question, for reflection to the number-of-copying-times management DB 101.

Here, the condition where copying is available refers, for example, to the condition where a relation expressed by: the number of total copying times 112a>the number of completed copying times 112b, is established in the acquired number of copying times information 112, and refers to the condition where the copying process is performed within the copy restriction items, if any, on the basis of the copy restriction item related information 113.

Then, the information recording apparatus 2 sets the disc ID 221, the number of copying times information 221 and the copy restriction item related information 223, based on the acquired copy management information 110. The information recording apparatus 2 also sets the contents attribute information 224 by acquiring it from a predetermined information source and sets the current time and date information acquired by a clock, which is possessed by the information recording apparatus 2, to the update time and date 225, to thereby store the copy management information 220 in the nonvolatile memory 217 (step S100).

On the other hand, if the copying process has not been selected by the user (NO at step S50), or if copying is not available (NO at step S70), the information recording apparatus 2 does not perform the copying process, but sets the disc ID 221, the number of copying times information 221 and the copy restriction item related information 223, based on the acquired copy management information 110. Also, the information recording apparatus 2 sets the contents attribute information 224 by acquiring it from a given information source and sets the current time and date information acquired from the clock, which is possessed by the information recording apparatus 2, to the update time and date 225, to thereby store the copy management information 220 in the nonvolatile memory 217 (step S100).

As a result, upon execution of the copying process (to be exact, the copying process at step S80 may not be executed, and thus upon insertion of an optical disc into the information recording apparatus 2 and acquirement of the copy management information 110 including the number of copying times information 112 from the server 1), the copy management information 220 concerning the digital contents recorded on the optical disc of a copy source are stored in the nonvolatile memory 217 of the information recording apparatus 2. Therefore, from this point onward, the number of copying times information of the digital contents recorded on the optical disc can also be managed in the information recording apparatus 2.

In the copying process shown in FIG. 5, the copy management information 110 only has to be acquired from the server 1 and the copy management information 220 only has to be stored in the nonvolatile memory 217. Alternatively, with the storage, a displaying process may be performed so that the copy management information 220 to be stored may be ensured to be displayed for the user. Also, in the copying process shown in FIG. 5, a determination on the availability of copying has been made (step S70) after determining whether or not the copying process has been selected by the user (step S50). However, the order may be reversed, that is, the determination on whether or not the copying process has been selected by the user may be ensured to be preceded by the determination on the availability of copying.

Further, in the copying process shown in FIG. 5, even when no copying process has been executed, the copy management information 220 that has been set with the disc ID 221, the number of copying times information 221, the copy restriction item related information 223, the contents attribute information 224 and the update time and date 225, may be ensured to be stored. If there is no change in the number of copying times information, only the update time and date 225 in the copy management information 220 may be ensured to be updated.

Referring to FIG. 6, hereinafter is described the number-of-copying-times information displaying process performed by the information recording apparatus 2.

When the user instructs the information recording apparatus 2 to display the number of copying times information, the information recording apparatus 2 acquires all the copy management information 220 stored in the nonvolatile memory 217 (step S110) and displays a list of the acquired copy management information 220 for every disc ID 221 on a screen display of an image display apparatus (e.g., TV) connected to the information recording apparatus 2 (step S120). FIG. 7 shows a screen example d10 of a list of the copy management information 220. The screen example d10 shown in FIG. 7 lists the contents attribute information (title, jacket picture, performers information, etc.), correlating with the number of copying times information (the number of total copying times, the number of completed copying times) and the restriction item related information. For example, as to the contents “Flight OOOO”, the list indicates that copying has already been performed twice out of four total copying times. As to the contents “SpΔΔ”, the list indicates that copying has already been performed once out of two total copying times and that, as the copy restriction items, the image size of a copy destination is restricted to a VGA size or less.

In this way, upon reception of display instructions from the user, the information recording apparatus 2 according to the present embodiment can always display the copy management information 220 including the number of copying times information 222, without the necessity of gaining access to the server 1 every time such instructions are received.

In the present embodiment, all the copy management information 220 stored in the nonvolatile memory 217 has been adapted to be presented to the user in the form of a list. However, the display mode for the copy management information 220 including the number of copying times information 222 is not limited to this, but other display modes may be used. For example, of the copy management information 220, only the contents instructed by the user may be ensured to be displayed. Further, in the above description, the copy management information 220 has been displayed on an image display apparatus connected to the information recording apparatus 2. Alternative to this, the copy management information 220 may be adapted to be displayed on a given information display section of the information recording apparatus 2. Also, indication of a non-copiable disc may be made noticeable by changing the color (e.g. gray indication), or may be made inconspicuous by reducing the size, or may be made easily exclusible from choices when copying is performed by displaying a message, for example, of “copy unavailable” or “only viewing”, or may be excluded from choices. Further, an attempt may be made to enhance convenience, for example, by performing sorting on the basis of the number of copy availabilities, and by separately displaying copy available discs and by displaying discs with a larger number of available copying times, so that the copying process can be performed by making a choice from the copy available candidates.

Referring now to FIG. 8, hereinafter is described the number-of-copying-times information updating process 1 performed by the information recording apparatus 2. This is a process of appropriately (regularly or irregularly; requirements for gaining access are preset to the information recording apparatus 2) gaining access to the server 1, of acquiring the copy management information 110 (the number of copying times information 112), and of updating the copy management information 220 (the number of copying times information 222) of the information recording apparatus 2, without the necessity of inserting an optical disc into the information recording apparatus 2. This process is based on the consideration that the information recording medium that has been managed as to the number of copying times information by the information recording apparatus 2 may not always be subjected to the copying process performed by the information recording apparatus 2, but may be subjected to the copying process performed by a different information recording apparatus. In other words, this process is based on the consideration that the number of copying times information 112 managed by the server 1 should be reflected to the number of copying times information 222 of the information recording apparatus 2, avoiding a situation that, if the copying process is performed by a different information recording apparatus, the number of copying times information 112 in the copy management information 110 managed by the server 1 will not coincide with the number of copying times information 222 in the copy management information 220 managed by the information recording apparatus 2.

Upon establishment of given requirements for executing the number-of-copying-times information updating process 1, the information recording apparatus 2 prepares disc IDs necessary for acquiring the number of copying times information 222 (step S210). The “disc IDs necessary for acquiring the number of copying times information 222” refers to all the disc IDs 221 in the copy management information 220 managed by the information recording apparatus 2, i.e. all the disc IDs 221 stored in the nonvolatile memory 217.

Then, the information recording apparatus 2 selects any one of the disc IDs 221 stored in the nonvolatile memory 217 (step S220), and gains access to the server 1 connected via the communication network 3, based on the selected disc ID 221, so that a server authentication process is performed (step S230).

After being authenticated by the server 1, the information recording apparatus 2 acquires the number of copying times information 112 from the server 1 (step S240). More specifically, the information recording apparatus 2 acquires the number of copying times information 112 of the disc ID 111 in question from the number-of-copying-times management DB 101, based on the selected disc ID 221.

Then, the information recording apparatus 2 reflects the acquired number of copying times information 112 to the number of copying times information 222 in the copy management information 220 of the disc ID 221 in question (step S250). As a result, the number of copying times information 222 in the copy management information 220 of the selected disc ID 221 will be updated to the latest number of copying times information, while time and date of updating the number of copying times information 222 are set to the update time and date 225 for storage in the nonvolatile memory 217.

Then, the information recording apparatus 2 determines whether or not the number of copying times information 222 has been acquired for all the required disc IDs 221 (step S260). When the number of copying times information 222 has been acquired for all the required disc IDs 221, the number-of-copying-times information updating process 1 is ended (YES at step S260). When the number of copying times information 222 has not been acquired for all the required disc IDs 221 (NO at step S260), control returns to step S220.

In this way, the information recording apparatus 2 according to the present embodiment appropriately gains access to the server 1 to acquire the number of copying times information related to the information recording medium. Therefore, if the digital contents recorded on the information recording medium in question are copied using a different information recording apparatus, no inconsistency will be caused in the number of copying times information.

As described above, the copy management system 10 according to the present embodiment is provided with: the server 1 that performs management, correlating a disc ID, which can univocally identify an information recording medium, with the number of copying times information of the digital contents recorded on the information recording medium; and the information recording apparatus 2 which is mutually communicable with the server 1 via the communication network 3. In the copy management system 10, the information recording apparatus 2, upon acquirement of the disc ID of an inserted information recording medium, acquires from the server 1 the number of copying times information of the acquired disc ID, for recordation in the memory. Then, when instructions for displaying the number of copying times information of information recording media are received from the user, the information recording apparatus 2 correlates the number of copying times information recorded on the memory with the disc IDs to display/output the information on/to the image display apparatus. As a result, the number of copying times information of the digital contents recorded on the information recording media can be conveniently presented to the user, without the necessity of inquiring the server 1 every time such instructions are received.

In other words, in the Managed Copy standard, the number of copying times information of the digital contents recorded on an optical disc can be easily presented to the user, without the necessity of inserting the optical disc into the information recording apparatus.

Further, with the copy management system 10 according to the present embodiment, the information recording apparatus 2 appropriately acquires the latest number of copying times information from the server 1 even when the digital contents recorded on the optical disc have been subjected to the copying process of a different information recording apparatus. Accordingly, a correct number of copying times information can be presented to the user.

The embodiment of the present invention has so far been described. Various modifications and changes may be made to the embodiment of the present invention within a scope not departing from the spirit of the present invention.

For example, the copy management system 10 of the above embodiment has been described based on the configuration that one information recording apparatus 2 is provided at the user's location. However, it may be so configured that a plurality of information recording apparatuses 2 are mutually communicable via a local communication network, such as LAN. In this case, the plurality of information recording apparatuses 2 connected via the LAN may be configured to mutually communicate on the number of copying times information 222. Thus, under the conditions where the digital contents are copied within a certain range (within the LAN), the plurality of information recording apparatuses 2 can mutually communicate on the number of copying times information even when communication is temporarily disabled with the server 1. Accordingly, the latest copy of the number of copying times information within the LAN can be reflected to the subject apparatus itself.

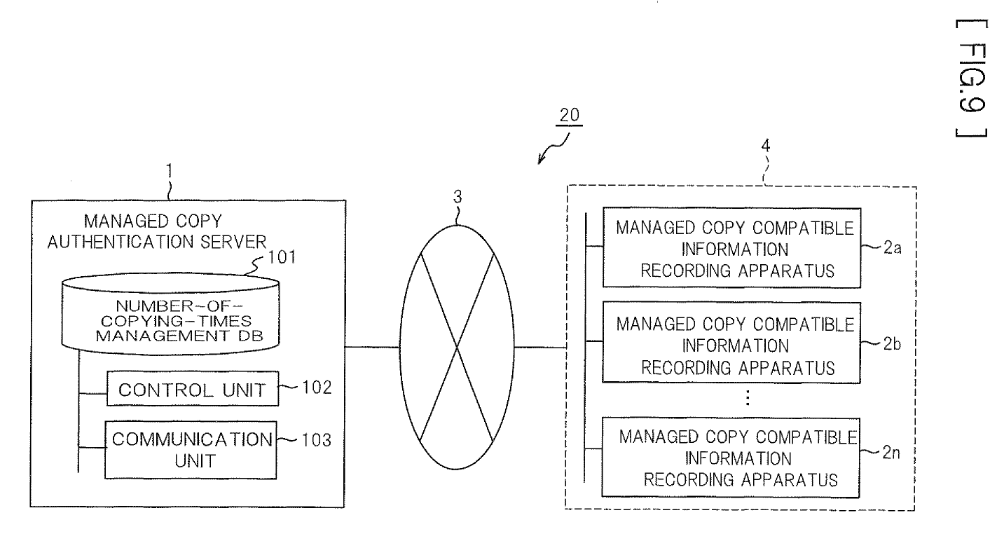

FIG. 9 is a schematic configuration diagram of a copy management system 20 in the case where a LAN 4 is configured by a plurality of information recording apparatuses 2a, 2b, . . . 2n. In addition to the copying process and the number-of-copying-times information updating process 1 described in the above embodiment, an information recording apparatuses 2i (i=a, b, . . . n) of the copy management system 20 perform a number-of-copying-times information updating process 2 in which the information recording apparatuses 2i mutually communicate on the number of copying times information.

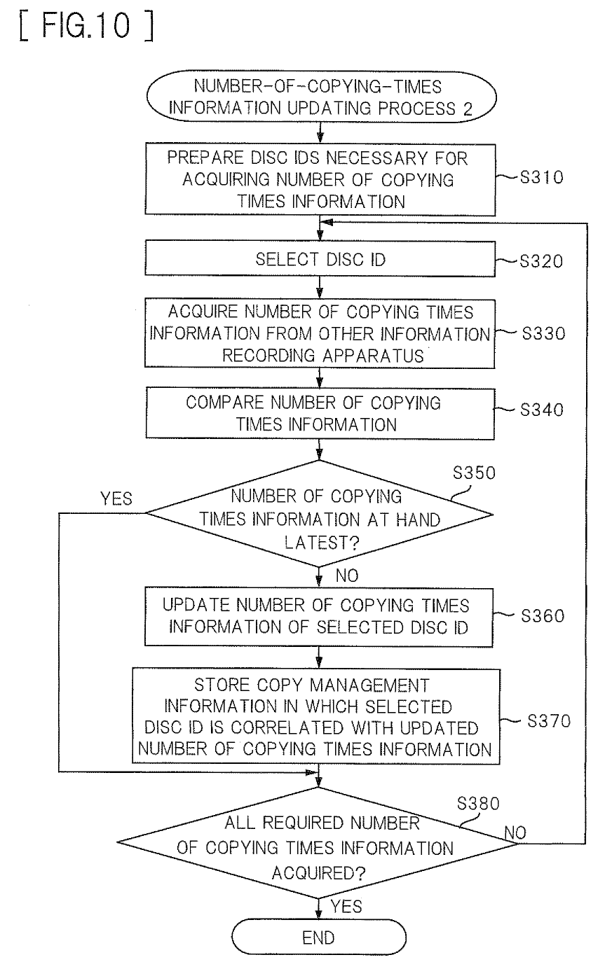

FIG. 10 is a flow diagram illustrating the number-of-copying-times information updating process 2 performed by each of the information recording apparatuses 2i. The following description will be provided assuming that the information recording apparatus 2a acquires the number of copying times information from other information recording apparatuses 2b, . . . , 2n.

Upon reception of the instructions for performing the number-of-copying-times information updating process 2 from the user, the information recording apparatus 2a prepares disc IDs necessary for acquiring the number of copying times information 222 (step S310). Here, the “disc IDs necessary for acquiring the number of copying times information 222” refers to all the disc IDs 221 in the copy management information 220 managed by the information recording apparatus 2a, i.e. all the disc IDs 221 stored in the nonvolatile memory 217 of the information recording apparatus 2a.

Then, the information recording apparatus 2a selects any one of the disc IDs 221 stored in the nonvolatile memory 217 (step S320).

Then, the information recording apparatus 2a gains access to other information recording apparatuses 2b, . . . , 2a connected via the LAN 4 and acquires the number of copying times information 222 and the update time and date 225 corresponding to the selected disc ID 221 from each of the nonvolatile memories 217 of other information recording apparatuses 2b, . . . , 2n (step S330).

Then, the information recording apparatus 2a compares the number of copying times information 222 of the selected disc ID 221, which information is possessed by itself, with the acquired number of copying times information 222 (step S340) to determine whether or not the number of copying times information 222 possessed by itself is the latest (step S350). In the comparison of the number of copying times information, the copy management information 220 having a small value in the number of completed copying times 222b may be determined as being the latest record, or the copy management information 220 having the update time and date 225 whose time and date are the latest may be determined as being the latest record.

When the number of copying times information 222 possessed by itself is not the latest (NO at step S350), the information recording apparatus 2a updates the number of copying times information 222 in the copy management information 220 of the disc ID 221 in question, based on the acquired latest number of copying times information 222 (step S360), and stores the updated copy management information 220 in the nonvolatile memory 217 (step S370). It should be appreciated that the time and date of executing the process concerned are set to the update time and date 225 in the copy management information 220.

On the other hand, when the number of copying times information of the information recording apparatus 2a is the latest, the processing at steps S360 and S370 described above will not be executed because there is no necessity of updating the number of copying times information 222.

Then, the information recording apparatus 2a determines whether or not the number of copying times information has been acquired for each of all the required disc IDs 221 (step S380). If the number of copying times information has been acquired for each of all the required disc IDs 221, the number-of-copying-times information updating process 2 is ended (YES at step S380). If the number of copying times information has not been acquired for each of all the required disc IDs 221 (NO at step 380), control returns to step S320.

In this way, the information recording apparatus 2a is able to acquire the number of copying times information 222 from each of other information recording apparatuses 2b, . . . , 2n within the LAN even when the server 1 cannot be accessed due to the occurrence of communication failure. Accordingly, assuming that the digital contents recorded on an information recording medium are subjected to a copying process within the LAN 4, the number of copying times information 222 of the information recording apparatus 2a can be updated to the latest information.

In other words, according to the copy management system 20 of the present modification, if the digital contents recorded on an optical disc are subjected to the copying process with an information recording apparatus 2i within the LAN 4, the information recording apparatus 2i may communicate with each of other information recording apparatuses 2i on the number of copying times information 222 even when connection cannot be established with the external communication network 3. Accordingly, the latest number of copying times information can be acquired, and the correct number of copying times information can be presented to the user.

The above embodiment has been described, dealing with the number of copying times management of the digital contents recorded on an information recording medium (optical disc). However, the technique of the number of copying times management according to the above embodiment is not limited to the digital contents recorded on an information recording medium (optical disc), but may also be applied to general digital contents delivered via a communication network. In this case, the number of copying times may be managed for every ID embedded in the contents to be delivered (e.g., combination of a contents ID identifying the title of the contents and a serial number, or the like, designated to each title; ID that can univocally identify the contents to be delivered) to restrict the number of copying times. As an example of usage, the user may be ensured to choose the number of copying times when purchasing digital contents and the price of the digital contents may be ensured to vary according to the number of copying times. In addition, the user may be ensured to have a chance of additionally purchasing the number of copying times after purchasing digital contents, i.e. may be ensured to have a chance of purchasing a predetermined number of copying times after completely using the allowable number of copying times.

In the above embodiment, the number of copying times has been always checked every time the copying process is carried out. Alternatively, a given copying process restriction period may be provided, so that the number of copying times may be ensured to be restricted during the copying process restriction period and that, after the copying process restriction period, the number of copying times may be ensured not to be restricted. For example, it may be so configured that, as to certain digital contents, the number of copying times restriction is released after expiration of a given period starting from the point of purchase, so that copies can be freely made.

1. An information recording apparatus which is mutually communicable with a number-of-copying-times management server via a communication network, the server performing management by correlating medium identification information that enables unique identification of an information recording medium with information related to number of allowable copying times of digital contents recorded on the information recording medium, the information recording apparatus comprising:
medium identification information acquiring means that acquires medium identification information of an inserted information recording medium;
first number-of-copying-times information acquiring means that acquires information related to number of allowable copying times from the number-of-copying-times management server, the number of allowable copying times being correlated with the medium identification information that has been acquired by the medium identification information acquiring means;
number-of-copying-times information recording means that records copy management information in a given storage unit, the copy management information being the information in which the medium identification information acquired by the medium identification information acquiring means is correlated with information related to the number of allowable copying times acquired by the first number-of-copying-times information acquiring means;
number-of-copying-times displaying/controlling means that effects control so that the copy management information recorded in the given storage unit can be displayed on or outputted to a given display unit, when a display request for the information related to the number of allowable copying times is received from a user;
second number-of-copying-times information acquiring means that acquires information related to number of allowable copying times from the number-of-copying-times management server when predetermined requirements have been satisfied, the information related to number of allowable copying times being correlated with each piece of medium identification information in copy management information which is recorded in the given storage unit; and
first number-of-copying-times information updating means that updates each piece of information related to number of allowable copying times in the copy management information recorded in the given storage unit, based on information related to number of allowable copying times acquired by the second number-of-copying-times information acquiring means and correlated with each piece of medium identification information.

2. (canceled)

3. The information recording apparatus according to claim 1, wherein
the information recording apparatus is provided in plural number, a plurality of the information recording apparatuses being mutually communicable via a local communication network; and
the information recording apparatus comprises:
third number-of-copying-times information acquiring means that acquires the information related to the number of allowable copying times from each of the other information recording apparatuses; and
second number-of-copying-times information updating means that compares, as to a single piece of medium identification information, the information related to the number of allowable copying times acquired by the third number-of-copying-times information acquiring means with the information related to the number of allowable copying times recorded in the given storage unit possessed by itself, and, when the information related to the number of allowable copying times acquired from each of the other information recording apparatuses is newer than the information related to the number of allowable copying times possessed by itself, updates the information related to the number of allowable copying times in the copy management information recorded in the given storage unit, based on the information related to the number of allowable copying times acquired from each of the other information recording apparatus.

4. The information recording apparatus according to claim 1, wherein the information related to the number of allowable copying times includes information related to number of total copying times preset to its information recording medium, and information related to current number of completed copying times.

5. The information recording apparatus according to claim 1, wherein the number-of-copying-times displaying/controlling means correlates contents attribute information of the digital contents, which information is possessed by the medium identification information, with the information related to the number of allowable copying times, with respect to all pieces of the copy management information recorded in the given storage unit, for listing.

6. The information recording apparatus according to claim 1, wherein
the number-of-copying-times management server performs management, further correlating the medium identification information with information related to copy restriction;
the first number-of-copying-times information acquiring means acquires information related to copy restriction from the number-of-copying-times management server, the information related to copy restriction being correlated with the medium identification information acquired by the medium identification information acquiring means;
the number-of-copying-times information recording means stores in the given storage unit the information related to copy restriction acquired by the first number-of-copying-times information acquiring means, the information being included in the copy management information; and
the number-of-copying-times displaying/controlling means outputs and displays copy management information including the information related to copy restriction on/to the given display unit.

7. The information recording apparatus according to claim 1, wherein the number-of-copying-times management server is a server in conformity with the standard of Managed Copy, and the information recording apparatus is the information recording apparatus in conformity with the standard of Managed Copy.

8. A copy management program readable by an information recording apparatus which is mutually communicable with a number-of-copying-times management server via a communication network, the server performing management by correlating medium identification information that enables unique identification of an information recording medium with information related to number of allowable copying times of digital contents recorded on the information recording medium, the program permitting the information recording apparatus to function as:
medium identification information acquiring means that acquires medium identification information of an inserted information recording medium;
first number-of-copying-times information acquiring means that acquires information related to number of allowable copying times from the number-of-copying-times management server, the number of allowable copying times being correlated with the medium identification information that has been acquired by the medium identification information acquiring means;
number-of-copying-times information recording means that records copy management information in a given storage unit, the copy management information being the information in which the medium identification information acquired by the medium identification information acquiring means is correlated with information related to the number of allowable copying times acquired by the first number-of-copying-times information acquiring means;
number-of-copying-times displaying/controlling means that effects control so that the copy management information recorded in the given storage unit can be displayed on or outputted to a given display unit, when a display request for the information related to the number of allowable copying times is received from a user;
second number-of-copying-times information acquiring means that acquires information related to number of allowable copying times from the number-of-copying-times management server when predetermined requirements have been satisfied, the information related to number of allowable copying times being correlated with each piece of medium identification information in copy management information which is recorded in the given storage unit; and
first number-of-copying-times information updating means that updates each piece of information related to number of allowable copying times in the copy management information recorded in the given storage unit, based on information related to number of allowable copying times acquired by the second number-of-copying-times information acquiring means and correlated with each piece of medium identification information.

9. (canceled)

10. The copy management program according to claim 8, wherein
the information recording apparatus is provided in plural number, a plurality of the information recording apparatuses being mutually communicable via a local communication network; and
the program further permits the information recording apparatus to function as:
third number-of-copying-times information acquiring means that
acquires the information related to the number of allowable copying times from each of the other information recording apparatuses; and
second number-of-copying-times information updating means that compares, as to a single piece of medium identification information, the information related to the number of allowable copying times acquired by the third number-of-copying-times information acquiring means with the information related to the number of allowable copying times recorded in the given storage unit possessed by itself, and, when the information related to the number of allowable copying times acquired from each of the other information recording apparatuses is newer than the information related to the number of allowable copying times possessed by itself, updates the information related to the number of allowable copying times in the copy management information recorded in the given storage unit, based on the information related to the number of allowable copying times acquired from each of the other information recording apparatus.
